(19) United States
(12) Patent Application Publication
(10) Pub. No.: US 2026/0338559 A1
(43) Pub. Date: Oct. 29, 2026

(54) VEHICLE POSITION ESTIMATION METHOD, DRIVING CONTROL METHOD, A NON-TRANSITORY COMPUTER-READABLE RECORDING MEDIUM, VEHICLE POSITION ESTIMATION DEVICE, AND MOBILE OBJECT

(71) Applicant: MoveEz, inc., Ishikawa (JP)

(72) Inventors: Sota IZUMI, Ishikawa (JP); Ryou YANASE, Ishikawa (JP); Keisuke YONEDA, Ishikawa (JP); Naoki SUGANUMA, Ishikawa (JP)

(21) Appl. No.: 19/656,279

(22) Filed: Apr. 23, 2026

(30) Foreign Application Priority Data
Apr. 24, 2025 (JP) 2025-072522

(51) Int. Cl. G01C 21/30; B60W 40/10; B60W 50/00; B60W 60/00

(52) U.S. Cl. CPC G01C 21/30; B60W 50/0097; B60W 40/10; B60W 2050/0022; B60W 60/001; B60W 2420/408; B60W 2556/40

(57) ABSTRACT

A vehicle position estimation method is a vehicle position estimation method for estimating the position of one's own vehicle, the method including an existence-probability acquisition step of using radar to acquire, for each position around the own vehicle, a first existence probability that is the probability of existence of an object; a radar cross-section acquisition step of using radar to acquire a first radar cross section that is the radar cross section of the object; a corrected-image generation step of generating a corrected image indicating the distribution of a first post-correction existence probability obtained by weighting the first existence probability using a first weight that is a weight corresponding to the first radar cross section; and an estimation step of estimating the position of the own vehicle using the corrected image.

### TECHNICAL FIELD

The present invention relates to a vehicle position estimation method, a driving control method, a program, a vehicle position estimation device, and a mobile object.

### BACKGROUND

Research on autonomous driving of mobile objects such as automobiles is being actively conducted (see Patent Document 1, for example). In autonomous driving of a mobile object, it is necessary to estimate the position of the mobile object. For example, a technique is known in which the position of a host vehicle on a map image is estimated by matching an observation image acquired by an imaging device such as radar (radio detection and ranging) or LiDAR (Light Detection and Ranging) with a map image representing a region corresponding to the observation image.

### PRIOR ART DOCUMENTS

### Patent Documents

Patent Document 1: JP 2020-026985 A

### SUMMARY OF INVENTION

### Problems to be Solved by the Invention

However, an observation image may contain not only positional information of objects that is useful for vehicle position estimation, but also positional information of objects that may adversely affect estimation accuracy. Examples of objects useful for vehicle position estimation include structures whose positions and shapes are stable, such as utility poles. On the other hand, examples of objects that may adversely affect estimation accuracy include unstable objects whose positions and shapes can change, such as vegetation and snow. Accordingly, in an observation image, positional information of useful objects for position estimation can be buried in positional information of unstable objects, which may degrade estimation accuracy.

In view of the foregoing, an object of the present invention is to suppress the influence of positional information of objects that may reduce vehicle position estimation accuracy when performing vehicle position estimation using observation images acquired by radar.

### Means for Solving the Problems

To achieve the above object, a vehicle position estimation method according to one aspect of the present invention is a vehicle position estimation method for estimating the position of one's own vehicle, the method being executed by a computer, and including an existence-probability acquisition step of using radar to acquire, for a plurality of positions around the own vehicle, a first existence probability that is the probability of existence of an object; a radar cross-section acquisition step of using the radar to acquire a first radar cross section that is the radar cross section of the object; a corrected-image generation step of generating a corrected image indicating the distribution of a first post-correction existence probability obtained by weighting the first existence probability using a first weight that is a weight corresponding to the first radar cross section; and an estimation step of estimating the position of the own vehicle using the corrected image.

Further, to achieve the above object, a travel control method according to one aspect of the present invention includes the above vehicle position estimation method and a travel control step of controlling travel of the own vehicle based on the position of the own vehicle estimated by the vehicle position estimation method.

Further, to achieve the above object, a program according to one aspect of the present invention is a program for causing a computer to execute the above vehicle position estimation method.

Further, to achieve the above object, a vehicle position estimation device according to one aspect of the present invention is a vehicle position estimation device that estimates the position of one's own vehicle, the device comprising an existence-probability acquisition unit configured to use radar to acquire, for each position around the own vehicle, a first existence probability that is the probability of existence of an object; a radar cross-section acquisition unit configured to use the radar to acquire a first radar cross section that is the radar cross section of the object; a corrected-image generation unit configured to generate a corrected image indicating the distribution of a first post-correction existence probability obtained by weighting the first existence probability using a first weight that is a weight corresponding to the first radar cross section; and an estimation unit configured to estimate the position of the own vehicle using the corrected image.

Further, to achieve the above object, a mobile body according to one aspect of the present invention comprises the vehicle position estimation device and a travel control unit configured to control travel of the own vehicle based on the position of the own vehicle estimated by the vehicle position estimation device.

These broad or specific aspects may be implemented as a system, method, integrated circuit, computer program, or non-transitory computer-readable recording medium such as a CD-ROM, and may be implemented by any combination of a system, method, integrated circuit, computer program, and recording medium.

### Effect of Invention

According to the present invention, in vehicle position estimation using observation images acquired by radar, it is possible to suppress the influence of the position information of objects contained in the observation image that can reduce the vehicle position estimation accuracy.

### BRIEF DESCRIPTION OF THE DRAWINGS

FIG. 1 is a block diagram illustrating an example of the configuration of a vehicle position estimation device and a mobile body according to an embodiment.

FIG. 2 is a graph showing the relationship, obtained when various objects are observed by radar, between radar cross section and the relative frequency in the case where the object was a stationary object.

FIG. 3 is a graph showing the relationship, obtained when various objects are observed by radar, between radar cross section and the relative frequency in the case where the object was vegetation.

FIG. 4 is an example of the approximate expressions of the probability density functions of stationary objects and vegetation, and a graph showing the probability that an observed object is a stationary object when the radar cross section is Rce.

FIG. 5 is a graph showing the relationship among variable PMax and probability PSp(Rce), and the first radar cross section (Rce).

FIG. 6 is a flowchart showing the flow of a vehicle position estimation method and a travel control method according to the embodiment.

FIG. 7 is a schematic plan view of the place where vehicle position estimation experiments were conducted using the vehicle position estimation device and vehicle position estimation method according to the embodiment, and a vehicle position estimation method of a comparative example.

FIG. 8 is a corrected image showing the existence probability of objects, obtained by the vehicle position estimation method of the comparative example at the place shown in FIG. 7.

FIG. 9 is a first example of the corrected image obtained by the vehicle position estimation device and vehicle position estimation method according to the embodiment at the place shown in FIG. 7.

FIG. 10 is a second example of the corrected image obtained by the vehicle position estimation device and vehicle position estimation method according to the embodiment at the place shown in FIG. 7.

FIG. 11 is a third example of the corrected image obtained by the vehicle position estimation device and vehicle position estimation method according to the embodiment at the place shown in FIG. 7.

FIG. 12 is a fourth example of the corrected image obtained by the vehicle position estimation device and vehicle position estimation method according to the embodiment at the place shown in FIG. 7.

### FORM FOR IMPLEMENTING INVENTION

Below, embodiments of the present invention will be described concretely with reference to the drawings.

The embodiments described below are each illustrative of general or specific examples. The numerical values, shapes, materials, components, positions and connection forms of components, steps, order of steps, etc., shown in the embodiments below are merely examples and are not intended to limit the present invention. Of the components in the embodiments below, components not described in the independent claims indicating the highest-level concept are described as optional components.

Each figure is a schematic diagram and is not necessarily strictly drawn to scale. In the figures, the same reference numerals denote the same constituent members.

(Embodiment) A vehicle position estimation method, program, vehicle position estimation device, and mobile body according to various aspects is described below.

### [Configuration of Vehicle Position Estimation Device and Mobile Body]

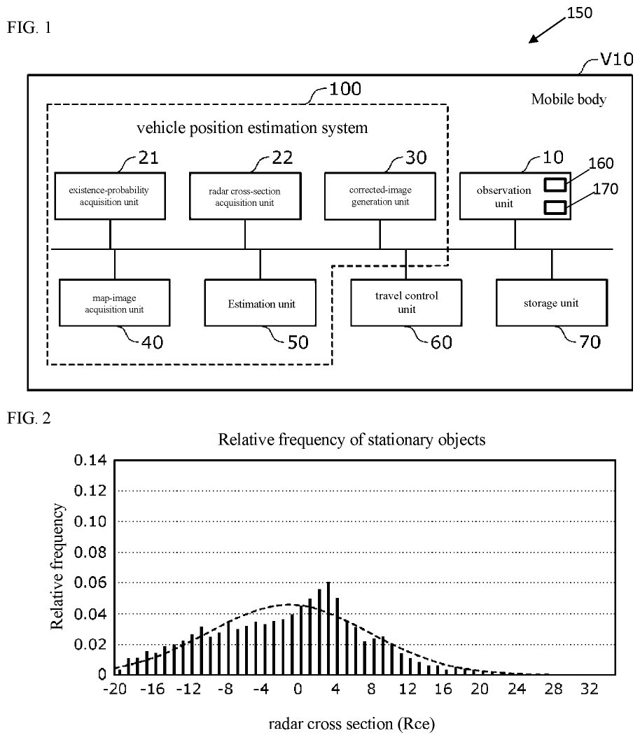

An exemplary configuration of a vehicle position estimation system and mobile body is illustrated in FIG. 1.

FIG. 1 is a block diagram illustrating an example of the configuration of a system 150 that includes a vehicle position estimation system 100 and a mobile body V10. The features of system 150 described below with reference to FIG. 1 are functional features that may be implemented by any combination of one or more hardware components. For example, one or more hardware processors may perform one or more aspects of the functions of the functional features of system 100. Reference to a “unit” below is intended to mean a functional unit-a discrete function performed by the given unit. A unit may be a discrete hardware component and/or may be one or more software programs executed by the same hardware processor or multiple hardware processors.

The mobile body V10 is a moving object provided with the vehicle position estimation system 100 and a travel control unit 60. The mobile body V10 may include an observation unit 10 and a storage unit 70. The mobile body V10 is not particularly limited as long as it is a mobile body whose movement can be at least partially controlled by the travel control unit 60. For example, the mobile body V10 may be a vehicle that performs automated driving.

The observation unit 10 observes the surroundings of the own vehicle. The own vehicle is the vehicle whose position is estimated by the vehicle position estimation system 100. In the illustrated example, the own vehicle is the mobile body V10. Hereinafter, the mobile body V10 is also referred to as the own vehicle.

In this embodiment, the observation unit 10 detects information related to the existence probability of objects at each position around the own vehicle by observing the surroundings of the own vehicle. Objects include any tangible matter. Objects include, for example, stationary objects, mobile bodies, vegetation, snow, and the like. A stationary object is an object that is stationary and whose shape does not change. Note that a stationary object may be an object in which minute movements or minute deformations that negligibly affect vehicle position estimation may occur. Stationary objects include, for example, man-made structures such as utility poles and buildings. The observation unit 10 includes at least one radar sensor 160. The radar sensor may be any radar sensor capable of measuring the radar cross section (RCS) of an object to be observed. The radar cross section is a value representing the degree of intensity of radio waves reflected from the target object toward the antenna when the antenna of the radar irradiates the target with radio waves. The observation unit 10 may include, for example, at least one millimeter-wave radar (MWR) sensor. The observation unit 10 may include an omnidirectional MWR system composed of a plurality of millimeter-wave radar sensors. In the omnidirectional MWR system, the plurality of millimeter-wave radar sensors emit millimeter waves in mutually different directions and receive reflected waves. The millimeter-wave radar, for example, observes the surroundings of the own vehicle at an observation cycle (e.g., an observation cycle of 20 Hz) and acquires observation information (e.g., distance to the observation target, azimuth angle where the observation target is located, and relative velocity with respect to the observation target). That is, the millimeter-wave radar acquires a number (e.g., 20) of frames of observation information per time period (e.g., per second) according to the observation cycle. Based on the observation information, the existence probability of an object at each position can be determined. By means of the observation unit 10, position information corresponding to the existence probability of objects such as roads and structures around them (such as traffic signals, guardrails, road signs, etc.) can be determined with high accuracy.

The existence probability is calculated by the observation unit 10, for example, using observation points indicating the positions of objects observed by radar and probability distributions indicating the probability that an object exists at the observation point. Specifically, an error ellipse indicating the error of the position of the observation point indicated by the observation result by radar is used as the probability distribution. The error includes, for example, errors in the installation position and installation angle of the radar, observation errors inherent to the radar itself, and the like. For example, an error ellipse is defined in which the correct position of an observation point exists with a probability of 95% or higher.

The radar included in the observation unit 10, as described above, can calculate the radar cross section of an object to be observed. The radar cross section is calculated based on the distance to the object to be observed, the intensity of the radio waves emitted from the radar, and the intensity of the radio waves reflected from the object toward the radar.

The observation unit 10 may generate a point cloud of observed targets based on the distant, azimuth and relative velocity information obtained by the radar sensors. The point cloud may include, for example, three-dimensional position information for the observed targets, relative velocity of the observed targets, and the radar cross-section of the observed targets.

The observation unit 10 may be configured for estimating the position and attitude angle of the mobile body V10. For example, the observation unit 10 may have a GNSS/INS (Global Navigation Satellite System/Inertial Navigation System) integrated navigation system 170.

The vehicle position estimation system 100 estimates the position of the own vehicle. In the example shown in FIG. 1, the vehicle position estimation system 100 includes an existence-probability acquisition unit 21, a radar cross-section acquisition unit 22, a corrected-image generation unit 30, a map-image acquisition unit 40, and an estimation unit 50. Note that the vehicle position estimation system 100 may include the observation unit 10.

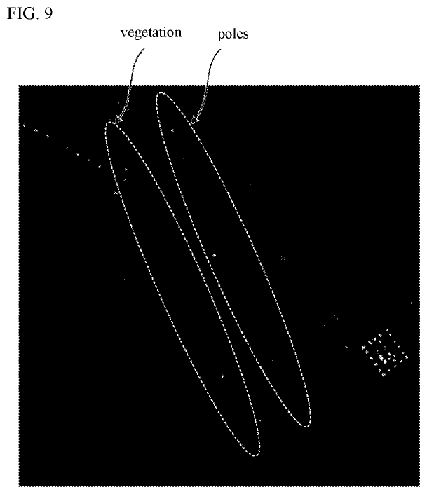

The existence-probability acquisition unit 21 may be configured to acquire, using radar data, a first existence probability that is the probability of existence of an object at a plurality of positions around the own vehicle. The existence-probability acquisition unit 21 may acquire the first existence probability from the observation unit 10. The first existence probability is acquired, for example, as an observation image. The observation image is a two-dimensional image including a plurality of pixels. Each pixel of the observation image corresponds to a particular position around the own vehicle. The observation image contains information corresponding to the first existence probability of an object at each pixel. The observation image may be composed of one frame of information acquired using the radar, or may be composed of a plurality of frames of information acquired using the radar. When the observation image is composed of a plurality of frames of information, the position of the own vehicle can differ between frames. Therefore, the observation image may be generated (e.g., by observation unit 10) by combining a plurality of frames of information while offsetting the relative positions of the plurality of frames in accordance with the movement amount of the own vehicle. The observation image may represent objects as viewed from above the own vehicle. The observation image may correspond to a predetermined area, with the own vehicle being centered in the observation image. The predetermined area may be, for example, a 10 m×10 m area centered at the own vehicle. The observation image may include any number of pixels. The number of pixels in an observation image may be, for example, 320 pix×320 pix. The size of each pixel depends on the size of the area covered by the observation image and the resolution of the observation image. For example, for a 320 pix×320 pix observation image covering a 40 m×40 m area, the size of each pixel in terms of the area around the vehicle that it captures may be 125 mm×125 mm. The observation image may be generated such that the position of the vehicle corresponds to the center of the observation image. FIG. 8 is an example of an observation image.

In the observation image, observation errors may be taken into consideration in generating the image. The observation error may be treated as an error ellipse on the observation image by calculating a covariance matrix based on the theory of error propagation. For example, a region considered to be where observation information can be obtained with a probability of 95% is defined as the inside of the error ellipse, and the pixel values of the pixels inside the error ellipse may be set to reflect the existence probability of an object.

When the observation image is composed of a plurality of frames of information and values are obtained for the same pixel in a plurality of frames, the values may be updated based on Bayes' rule.

The radar cross-section acquisition unit 22 may acquire a first radar cross section information that is the radar cross section of an object around the own vehicle. The radar cross-section acquisition unit 22 may acquire the first radar cross section measured by the radar sensor(s) of the observation unit 10. The first radar cross section information acquired by the radar cross-section acquisition unit may be in the form of a two-dimensional image comprising radar cross-section information for objects in a region around the vehicle.

The corrected-image generation unit 30 may generate a corrected image. The corrected image indicates the distribution of a first post-correction existence probability obtained by weighting the first existence probability using a first weight that is a weight corresponding to the first radar cross section. The weighting according to this embodiment is a technique in which a first weight having a numerical value that differs depending on the first radar cross section of the object pertaining to the first existence probability is applied to the first existence probability. For example, the weighting may be performed by multiplying each first existence probability by the first weight corresponding to that first existence probability. Details of the method for generating the corrected image will be described later.

The map-image acquisition unit 40 may acquire one or more map images that include a map of a region that includes the position of the own vehicle. The position of the own vehicle used when the map-image acquisition unit 40 acquires the map image may be, for example, estimated based on the measurement result of the GNSS/INS integrated navigation system. For example, the position of the own vehicle may be estimated by Dead Reckoning (DR), which estimates the position of the own vehicle by integrating its speed. Additionally, or alternatively, the position of the own vehicle may be estimated based on the position of the own vehicle estimated immediately before by the vehicle position estimation system 100 and the speed of the own vehicle. In this embodiment, the map image is a two-dimensional image including a plurality of pixels. The map image is generated by traveling with, for example, a mapping vehicle along roads and the like where vehicle position estimation may be performed, using the existence probability of objects acquired by radar and the radar cross section. For example, a mapping vehicle configured with one or more of the features described herein may traverse roads of a region and collect data for generating one or more map images. The collected data may be used to generate one or more map images of the region. The one or more map images may be generated by the mapping vehicle as it traverses the region or may be generated by a separate computing system that receives the collected data from the mapping vehicle. For example, the mapping vehicle may upload the collected data to a server via one or more wired and/or wireless communication links, and the server may include one or more software programs for generating one or more map images based on the collected data. Optionally, map images may be generated from data collected by multiple mapping vehicles. One or more map images may be updated over time based on newly collected data to account for changes over time in stationary objects in the region. The map image may indicate the distribution of a second post-correction existence probability obtained by weighting, using a second weight that is a weight corresponding to a second radar cross section acquired in advance using radar, a second existence probability that is the existence probability of objects in the region. Optionally, the a plurality of map images are stitched together into a plurality of patches, each patch corresponding to a predetermined planar area (e.g., a city, a town, a village, a neighborhood, or a portion thereof). The map of the region that includes the position of the own vehicle may be based on the plurality of patches.

The map image is generated before the existence-probability acquisition unit 21 acquires the first existence probability. The second existence probability is acquired using radar before the existence-probability acquisition unit 21 acquires the first existence probability, and the second radar cross section is acquired using radar before the radar cross-section acquisition unit 22 acquires the first radar cross section. The map image is composed of a plurality of frames of information acquired by radar. The map image is generated by combining a plurality of frames of information. Further, in the map image, the existence probability of objects that are mobile bodies such as vehicles may be removed. For example, data from one or more other sensor systems may be used to determine which objects are vehicles and the radar data associated with the vehicles may be corrected accordingly. Other sensor systems that may be used to identify objects that are mobile bodies include, for example, cameras and LiDAR sensors. One or more object detection algorithms may be used by a computing system to identify the mobile objects in the camera images and/or LiDAR images, and the radar data associated with the identified mobile objects may be corrected accordingly. The method of generating the map image will be described later. Note that the map image is not limited to the above example and may be any image including a map of a region. For example, as the map image, an image indicating the distribution of the existence probability of objects acquired by radar in clear weather without snow accumulation may be used. Alternatively, as the map image, an image acquired using a sensor other than radar such as LiDAR may be used. The map image(s) may be stored in the map-image acquisition unit 40 or in the storage unit 70. Multiple map images may be stored. For example, each map image may include 100 m×100 m region and multiple map images may be stored that collectively cover a larger region, such as an entire region through which a vehicle map traverse.

The estimation unit 50 may estimate the position of the own vehicle using the corrected image generated by the corrected-image generation unit 30. The estimation unit 50 may estimate the position of the own vehicle based on the corrected image and the map image. The estimation unit 50 performs map matching between the corrected image and the map image. In the map matching, for example, template matching is used. In this case, by using the map image as the search target image and the corrected image as the template image and performing similarity calculation, a correlation distribution is obtained. As the similarity calculation, for example, Zero-mean Normalized Cross Correlation (ZNCC) is used.

The travel control unit 60 may control travel of the own vehicle. In this embodiment, the travel control unit 60 controls travel based on the position of the own vehicle estimated by the estimation unit 50. The travel control unit 60, for example, controls the traveling direction of the own vehicle based on the position of the own vehicle and the map information stored in the storage unit 70.

The storage unit 70 stores information for estimating the position of the own vehicle. For example, the storage unit 70 stores map information such as the map image acquired by the map-image acquisition unit 40 and information on roads on which the own vehicle is driven, such as stationary structural landmarks such as road edges, lane boundaries, guardrails, telegraph poles, and buildings. The storage unit 70 may also store various information for automated driving, such as route data, intersection geometry, traffic regulations (e.g., speed limits, stop lines), and drivable-area information for decision-making.

### [Methods for Generating Corrected Image and Map Image]

First, an exemplary method for generating the corrected image will be explained. According to various embodiments, in order to suppress the influence of position information of objects that can cause a reduction in vehicle position estimation accuracy, the observation image is corrected. Objects that can cause a reduction in vehicle position estimation accuracy may include whose shapes and positions can change over time, such as vegetation, snow, pedestrians, intermittently stopping vehicles, swaying signs or fabric due to wind, and drifting leaves (hereinafter referred to as non-stationary objects). Such non-stationary objects tend to have smaller radar cross sections than stationary objects, such as man-made structures, whose shapes and positions change little over time. Using this tendency, by weighting the first existence probability using a first weight corresponding to the first radar cross section, the existence probability of non-stationary objects is reduced.

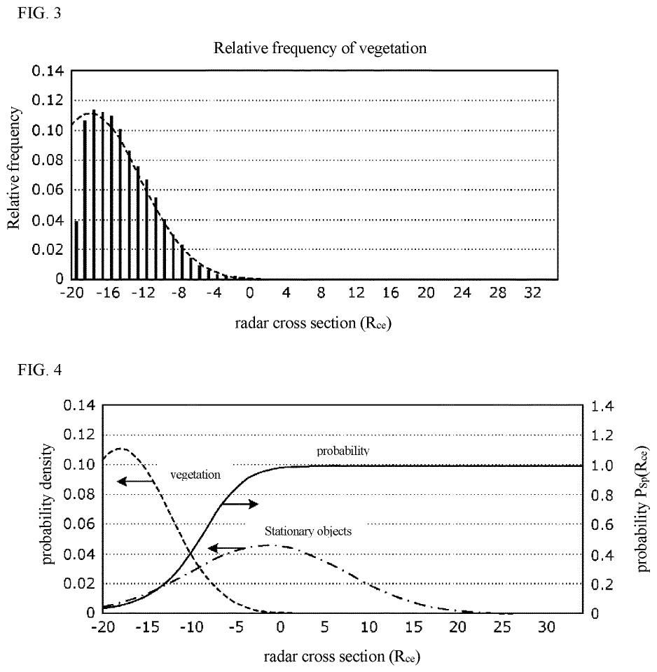

The relationship between the radar cross section and the object will be explained with reference to FIGS. 2 and 3. FIG. 2 is a graph showing the relationship, obtained when various objects are observed by radar, between the radar cross section and the relative frequency in the case where the object was a stationary object. FIG. 3 is a graph showing the relationship, obtained when various objects are observed by radar, between the radar cross section and the relative frequency in the case where the object was vegetation. In FIGS. 2 and 3, the relative frequencies are shown by bar graphs. In FIGS. 2 and 3, approximate curves treated as probability density distributions obtained by approximating the distributions of the respective relative frequencies with normal distributions are also shown by broken lines.

As shown in FIGS. 2 and 3, vegetation tends to have a smaller radar cross section than stationary objects. The radar cross section at which the relative frequency of stationary objects peaks is larger than the radar cross section at which the relative frequency of vegetation peaks. Therefore, letting the radar cross section be denoted by Rce, the relative frequency of stationary objects be denoted by Fs(Rce), and the relative frequency of vegetation be denoted by FG(Rce), the probability PS(Rce) that an observed object is a stationary object when the radar cross section is Rce can be approximately expressed by the following expression.

$$[ Number 1 ]$$

$${P}_{S} ( {R}_{c e} ) = \frac{{F}_{S} ( {R}_{c e} )}{{F}_{S} ( {R}_{c e} ) + {F}_{G} ( {R}_{ce} )} \qquad ( 1 )$$

Next, the distributions of the relative frequencies of stationary objects and vegetation are approximated by normal distributions and treated as probability density functions. The arithmetic mean μS of stationary objects is −1.34 and the standard deviation σS is 8.73. Using these arithmetic mean μS and standard deviation σS, the probability density function of stationary objects can be approximated by the following expression.

$$[ Number 2 ]$$

$${f}_{Sp} ( {R}_{c e} ) = \frac{1}{\sqrt{2 π} {σ}_{S}} exp \{ - \frac{{( {R}_{ce} - {μ}_{S} )}^{2}}{2 {σ}_{S}^{2}} \} \qquad ( 2 )$$

Assuming that the distribution of the relative frequency of vegetation is symmetric to the left and right, and extending the distribution of the relative frequencies shown in FIG. 3 to the range where the radar cross section Rce is less than or equal to −20, the arithmetic mean μG of vegetation is −18.00 and the standard deviation σG is 5.60. Using these arithmetic mean μG and standard deviation σG, the probability density function of vegetation can be approximated by the following expression.

$$[ Number 3 ]$$

$${f}_{Cp} ( {R}_{ce} ) = \frac{1}{{I}_{0}} \frac{1}{\sqrt{2 π} {σ}_{G}} exp \{ - \frac{{( {R}_{ce} - {μ}_{G} )}^{2}}{2 {σ}_{G}^{2}} \} \qquad ( 3 )$$

Here, the constant I0 shown in Expression (3) is expressed by the following expression:

$$[ Number 4 ]$$

$${i}_{0} = {\int }_{- 20}^{∞} \frac{1}{\sqrt{2 π} {σ}_{G}} exp \{ - \frac{{( {R}_{ce} - {μ}_{G} )}^{2}}{2 {σ}_{G}^{2}} \} d {R}_{ce} \qquad ( 4 )$$

Using the above approximate expressions, the probability PSp(Rce) that an observed object is a stationary object when the radar cross section is Rce can be approximately expressed by the following expression.

$$[ Number 5 ]$$

$${P}_{Sp} ( {R}_{ce} ) = \frac{{f}_{Sp} ( {R}_{ce} )}{{f}_{Sp} ( {R}_{ce} ) + {f}_{Gp} ( {R}_{ce} )} \qquad ( 5 )$$

One example of these approximate expressions and probabilities is shown in FIG. 4. FIG. 4 is an example of a graph showing the approximate expressions of the probability density functions of stationary objects and vegetation, and the probability PSp(Rce) that an observed object is a stationary object when the radar cross section is Rce.

In the example shown in FIG. 4, in the range where the radar cross section Rce is −20 or more and about 5 or less, the probability PSp(Rce) decreases as the radar cross section Rce decreases, and in the range where the radar cross section Rce is about 5 or more, the probability PSp(Rce) is almost constant.

As described above, the probability PSp(Rce) corresponds to the first weight, which is a weight corresponding to the first radar cross section acquired by the radar cross-section acquisition unit 22. As described above, the first weight is determined based on the relationship between the value of the first radar cross section and the probability that the object is a stationary object. In this embodiment, the probability PSp(Rce), which is a function of the first radar cross section (Rce) as shown in FIG. 4, is determined as the first weight. Note that the first weight need not be the probability PSp(Rce) itself. For example, the first weight may be another function determined based on the probability PSp(Rce).

The first weight for an object that is vegetation is smaller than the first weight for an object that is a stationary object. Note that, for example, when the object is snow, the first weight can be set in the same manner as when the object is vegetation. That is, the first weight for an object that is snow is smaller than the first weight for an object that is a stationary object.

In the example shown in FIG. 4, if a first value, which is one of the values of the first radar cross section, is set to a value of 5 or less, then the first weight corresponding to a first radar cross section smaller than the first value is smaller than the first weight corresponding to a first radar cross section greater than the first value.

Next, an exemplary method for generating the corrected image will be described. As described above, the corrected-image generation unit 30 generates a corrected image indicating the distribution of a first post-correction existence probability obtained by weighting the first existence probability for an object using a first weight corresponding to the first radar cross section of the object. The weighting may be performed by multiplying the first existence probability by the first weight corresponding to the first existence probability. As described above, the first weight may be the probability PSp(Rce), which is a function of the first radar cross section (Rce).

In generating the corrected image, first, the first existence probabilities of objects within a region around the vehicle is calculated. Specifically, based on the observation results of the radar included in the observation unit 10, an error ellipse indicating the error of the position of the observation point indicated by the observation result is determined. A two-dimensional probability distribution indicating the existence probability of the observation point within the error ellipse is also determined.

Next, for each pixel in the observation image acquired from the radar, an integral value V (that is, the volume of the probability distribution) of the probability distribution within the pixel is calculated. In this embodiment, the integral value V is calculated by accumulating the probability distributions for the observation images of a plurality of frames acquired by radar. This integral value V corresponds to the first existence probability. If the arithmetic mean of the integral value V at each pixel is denoted by μV and the standard deviation is denoted by σV, the calculated integral value V is converted into a first post-correction existence probability Pe, which is the existence probability of an object at the pixel, by the following expression.

$$[ Number 6 ]$$

$${P}_{e} = \frac{{P}_{M ax} - {P}_{M i n}}{{μ}_{V} + 3 {σ}_{V}} V + {P}_{M i n} \qquad ( 6 )$$

Here, PMax and PMin in Expression (6) are expressed by the following expressions using the probability PSp(Rce) and constants PMax,Const and PMin,Const.

[Number 7]

P_{Max}=P_{Sp}(R_{ce})(P_{Max,Const}−P_{Min,Const})+P_{Min,Const} (7)

[Number 8]

P_{Min}=P_{Min,Const} (8)

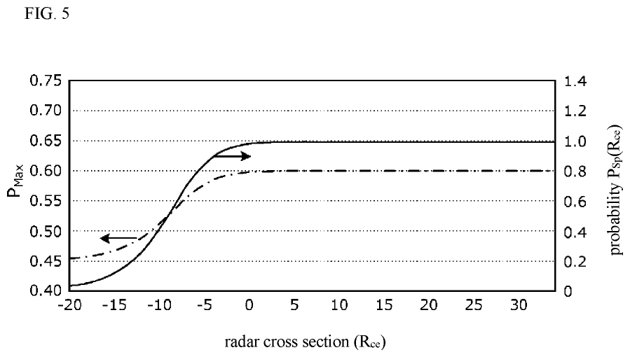

The variable PMax used here will be described with reference to FIG. 5. FIG. 5 is a graph showing the relationship among the variable PMax and the probability PSp(Rce), and the first radar cross section (Rce). In an exemplary embodiment, the constants PMax,Const and PMin,Const are set to 0.6 and 0.45, respectively. In the example illustrated in FIG. 5, the variable PMax is a variable that changes between about 0.45 and 0.6 according to the value of the first radar cross section. By using such a variable PMax, it is possible to perform weighting on the integral value V corresponding to the first existence probability using the first weight corresponding to the first radar cross section.

A corrected image can be generated by mapping the value of the first post-correction existence probability Pe calculated in this way as the pixel value of each pixel.

As described above, the corrected-image generation unit 30 generates a corrected image indicating the distribution of the first post-correction existence probability Pe obtained by weighting the first existence probability using the first weight corresponding to the first radar cross section.

The map image may be generated in the same manner as the corrected image, such as using radar data collected by one or more mapping vehicles that traversed the region associated with the map image. As described above, the map image indicates the distribution of a second post-correction existence probability obtained by weighting, using a second weight corresponding to a second radar cross section acquired in advance using radar, a second existence probability that is the existence probability of objects acquired in advance using radar. The second existence probability is calculated in the same manner as the first existence probability, the second weight is calculated in the same manner as the first weight using the second radar cross section, and the second post-correction existence probability is calculated in the same manner as the first post-correction existence probability.

FIG. 13A illustrates an exemplary method for generating a map image and/or a corrected image according to the principles discussed above. The method may be performed by a suitable computing system that includes one or more processors and memory storing one or more programs for execution by the one or more processors for causing the computing system to perform the steps of method 1300. The method may be performed by a computing system of a vehicle, such as mobile body V10, and/or may be performed by a computing system of a fixed installation, such as a server of a mapping service. At step 1302, radar data collected by a suitable system, such as a vehicle that includes observation unit 10 (e.g., mobile body V10) or a mapping vehicle, is analyzed to identify stationary objects 1320 represented in the radar data. The stationary objects 1320 may be identified based on their stationary positions over multiple frames of radar data collected as the vehicle moves, based on their relative velocities as represented in the radar data, and/or based on any other suitable information. Step 1302 may include generating an initial map image from the radar data associated with the stationary objects 1320. Non-stationary objects 1330 may be omitted from the initial map image. The non-stationary objects 1330 may be identified as non-stationary objects (e.g., based on a having a non-zero velocity) or may be objects that are not identified as stationary objects. The initial map image can be a two-dimensional image represent objects as if imaged from above and can have predefined dimensions representing a region around (e.g., surrounding, in front of, behind, to a driver's side, to a passenger's side, etc.) the vehicle that captured the radar data. At step 1304, an error ellipse is determined for each stationary object. The error ellipse may be determined based on estimates of error associated with the radar data collection, as discussed above. At step 1306, existence probabilities are determined for each pixel of the initial map image based on the error ellipses of the stationary objects. The value associated with a given pixel is proportional to the probability of a stationary object at the pixel. In FIG. 13A, a pixel 1342 corresponding to a stationary object 1344 has a relatively large value corresponding to a high probability of the object 1344 being at that location. Surrounding pixels (e.g., pixel 1346) have values associated with their relative probabilities of having the object 1344 in accordance with the determined error ellipse 1348. The pixels may be registered to real-world positions based on GPS position and/or heading data collected along with the radar data and/or based on accumulating multiple frames. Next, the radar cross section information in the radar data is used to further filter non-stationary objects from the initial map image. FIG. 13B illustrates an exemplary approach for such filtering. A radar cross-section map 1360 and the initial map image 1362 are combined to produce a corrected map image 1364. The radar cross-section map 1360 may include weights associated with pixels of the corrected map image 1364. The weights are derived from the radar cross-section information of the radar data. Existence probabilities of the initial map image 1362 that are associated with objects having low radar cross-sections are suppressed in the corrected map image 1364 via the weighting process. The above method may be performed for in similar fashion for generating a corrected observation image.

### [Vehicle Position Estimation Method]

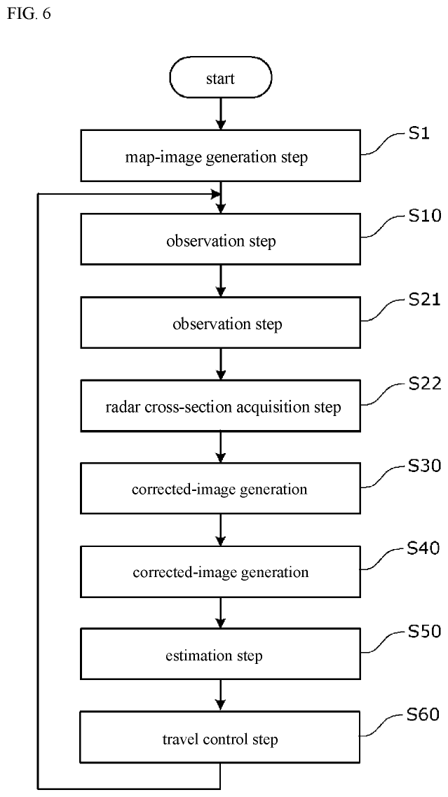

An example of a vehicle position estimation method and travel control method according to various embodiments is illustrated in FIG. 6. FIG. 6 is a flowchart showing the flow of the vehicle position estimation method and the travel control method according to various embodiments. Below, a vehicle position estimation method using the vehicle position estimation system 100 according to various embodiments and a travel control method using the mobile body V10 will be described.

The vehicle position estimation method according to various embodiments is a method for estimating the position of the own vehicle (that is, the mobile body V10). The steps of the vehicle position estimation method may be performed by a computing system. For example, one or more steps of the method may be performed by a computing system of a vehicle. Different steps may be performed by different computing systems. For example, Step S1 may be performed by a computing system of a mapping vehicle (i.e., off-line) and the other steps may be performed by a computing system of the vehicle who's position is being determined.

As shown in FIG. 6, the vehicle position estimation method according to various embodiments may include a map-image generation step S1, an observation step S10, an existence-probability acquisition step S21, a radar cross-section acquisition step S22, a corrected-image generation step S30, a map-image acquisition step S40, and an estimation step S50. The travel control method according to this embodiment includes each step included in the vehicle position estimation method and a travel control step S60.

As shown in FIG. 6, in the vehicle position estimation method and the travel control method according to various embodiments, first, a map image including a map of a given region is generated (map-image generation step S1). The map image indicates the distribution of a second post-correction existence probability obtained by weighting, using a second weight corresponding to a second radar cross section acquired before the existence-probability acquisition step S21 using radar, a second existence probability that is the existence probability of objects acquired before the existence-probability acquisition step S21 using radar. In generating the map image, for example, the second existence probability may be acquired by the existence-probability acquisition unit 21 of the vehicle position estimation system 100. The second radar cross section may be acquired, for example, by the radar cross-section acquisition unit 22. The map image may be generated, for example, by the corrected-image generation unit 30.

Optionally, the required map image(s) are pre-stored (e.g., in storage 70) and step S1 is not performed.

Next, the observation unit 10 of the vehicle position estimation system 100 observes the surroundings of the own vehicle (observation step S10). In this embodiment, in the observation step S10, the observation unit 10 detects information related to the existence probability of objects at each position around the own vehicle by observing the surroundings of the own vehicle. In the observation step S10, the observation unit 10 also measures the radar cross section of an object to be observed.

Next, the existence-probability acquisition unit 21 acquires, using radar, a first existence probability that is the probability of existence of an object at a plurality of positions around the own vehicle (existence-probability acquisition step S21).

Next, the radar cross-section acquisition unit 22 acquires, using radar, a first radar cross section that is the radar cross section of the object (radar cross-section acquisition step S22).

Next, the corrected-image generation unit 30 generates a corrected image indicating the distribution of a first post-correction existence probability obtained by weighting the first existence probability using a first weight corresponding to the first radar cross section (corrected-image generation step S30). In this embodiment, the first weight is determined based on the relationship between the value of the first radar cross section and the probability that the object is a stationary object. In this case, the first weight for an object that is vegetation is smaller than the first weight for an object that is a stationary object. Also, the first weight corresponding to a first radar cross section smaller than a first value predetermined is smaller than the first weight corresponding to a first radar cross section greater than the first value.

Next, the map-image acquisition unit 40 acquires a map image including a map of a region including the position of the own vehicle (map-image acquisition step S40). The map image may be based on the plurality of patches of stitched together map images stored in a memory. The map image may be one of the patches, may be a sub-portion of one of the patches, or may include multiple patches or portions of multiple different patches. For example, a map image may be an area of a predetermined distance around the position of the own vehicle and, as such, may be any combination of any portion stitched together patches that include the predetermined distance around the position of the own vehicle. The map image may be acquired at step S40 by vehicle position estimation system 100. For example, one or more pre-generated map images may be downloaded from a map image repository, such as a repository of a map image service provider that obtains radar data and generates map images for various different geographic regions. A vehicle, such as vehicle V10 may have a wireless communication system, such as a WiFi system or satellite communication system, and may download one or more map images from a map image repository. One or more map images may be downloaded as the vehicle is traversing roads or may be downloaded well in advance. One or more map images may be acquired based on a planned route of a vehicle. For example, a vehicle may have a planned destination and one or more planned routes to reach the destination and may acquire one or more map images for the one or more planned routes. Each map image may cover a portion of a given route and, thus, a plurality of map images may be acquired that cover the entire planned route. As noted above, the map images may be stored in a memory of the vehicle, such as storage 70.

Next, the estimation unit 50 estimates the position of the own vehicle using the corrected image (estimation step S50). In this embodiment, in the estimation step S50, the position of the own vehicle is estimated based on the corrected image and the map image. FIG. 14 illustrates an example of how the corrected image and map image may be used to estimate the position of the own vehicle. The observation image 1402 may be smaller in geographic area than the map image 1404 (e.g., the map image 1404 may be twice the size of the observation image). The observation image 1402 may be compared to regions of the map image 1404 of corresponding size (e.g., by scanning the observation image 1402 across the map image 1404), with a correlation determined for each comparison, resulting in a correlation distribution 1406. The position of the own vehicle may be determined based on the location of the correlation distribution 1406 having the highest correlation.

In some examples, an initial position estimation from a GNSS system may be used to determine which of a plurality of map images to use for comparing with the observation image 1402. For example, for a given trip, the first observation image may be compared to a map image based on an initial estimate of vehicle position obtained via the GNSS system. The initial estimate of vehicle position may be updated based on the position estimation described above. The map image(s) may be correlated with real-world position information (e.g., the longitude and latitude for each pixel may be known and embedded in, or otherwise associated with, the map image) such that correlating the observation image with the map image provides the position of the own vehicle.

Next, in the travel control method according to this embodiment, the travel control unit 60 of the mobile body V10 performs travel control of the own vehicle based on the position of the own vehicle estimated by the vehicle position estimation method according to this embodiment (travel control step S60).

Thereafter, the process returns to the observation step S10 and the same processing is repeated. Note that, after the travel control step S60, the process may return to the map-image generation step S1 again to update and add the map image.

As described above, by the vehicle position estimation method according to this embodiment, the position of the own vehicle can be estimated. Also, by the travel control method according to this embodiment, travel control of the mobile body V10 can be performed.

### Effects, Etc.

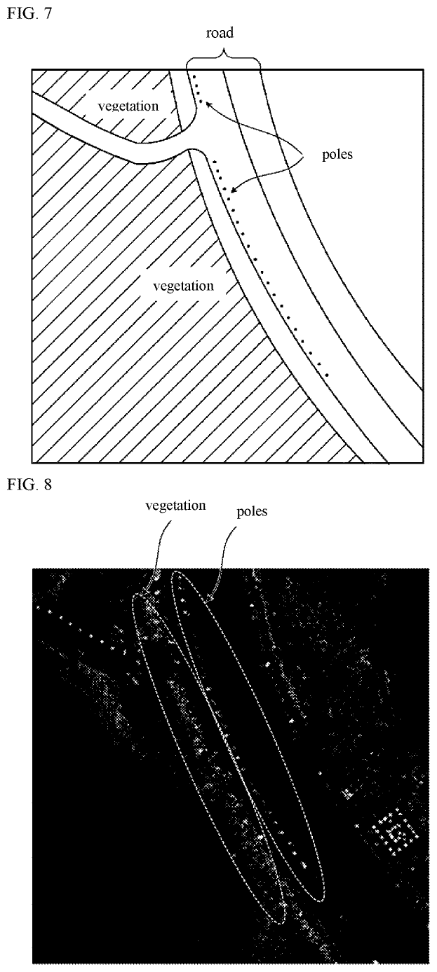

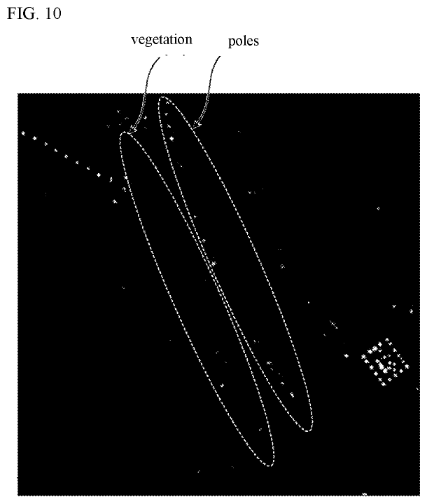

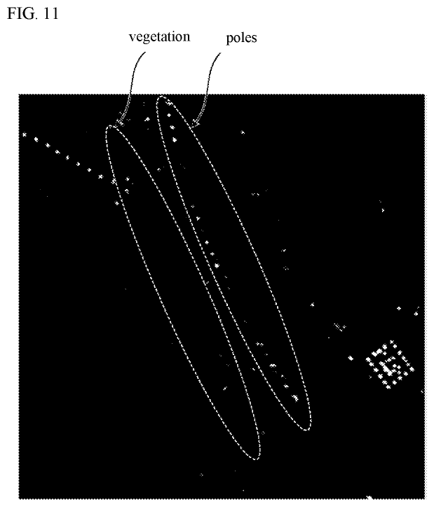

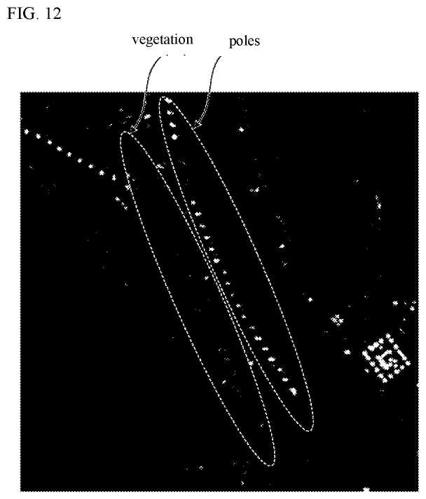

The effects of the vehicle position estimation method according to this embodiment and the like will be described with reference to FIGS. 7 to 12 while comparing with a comparative example. FIG. 7 is a schematic plan view of the place where vehicle position estimation experiments were conducted using the vehicle position estimation system 100 and the vehicle position estimation method according to this embodiment and the vehicle position estimation method of a comparative example. FIG. 8 is a corrected image showing the existence probability of objects obtained by the vehicle position estimation method of the comparative example at the place shown in FIG. 7. FIGS. 9 to 12 are examples of corrected images obtained by the vehicle position estimation system 100 and the vehicle position estimation method according to this embodiment at the place shown in FIG. 7. In FIGS. 9 to 12, the combinations of the constants PMax,Const and PMin,Const differ from each other. In the example shown in FIG. 9, (PMax,Const, PMin,Const)=(0.6, 0.45); in the example shown in FIG. 10, (PMax,Const, PMin,Const)=(0.65, 0.45); in the example shown in FIG. 11, (PMax,Const, PMin,Const)=(0.6, 0.475); and in the example shown in FIG. 12, (PMax,Const, PMin,Const)=(0.65, 0.475).

As shown in FIG. 7, at the place where the experiments were conducted, a plurality of poles were installed near the edges in the width direction of the road, and vegetation was present along the road. The poles shown in FIG. 7 are an example of stationary objects.

In the corrected image of the comparative example vehicle position estimation method, pixel values corresponding to probabilities calculated by an expression similar to Expression (6) are set. The comparative example differs from this embodiment in that PMax and PMin are constants rather than variables. That is, in the comparative example, PMax and PMin do not change according to the radar cross section of an object. In the example shown in FIG. 8, PMax=0.6 and PMin=0.45.

As shown in FIG. 8, in the comparative example, images corresponding to the poles and vegetation are shown. In contrast, in the embodiment shown in FIGS. 9 to 12, images corresponding to the poles are present, but images corresponding to vegetation are greatly reduced compared with the comparative example.

Thus, in this embodiment, by using a corrected image indicating the distribution of the first post-correction existence probability obtained by weighting the first existence probability using the first weight corresponding to the first radar cross section, it is possible to suppress the influence of position information of objects such as vegetation, which can reduce the vehicle position estimation accuracy, contained in the observation image. Accordingly, since the position information of stationary objects is prevented from being buried in the position information of vegetation and the like, it is possible to suppress a reduction in vehicle position estimation accuracy due to vegetation and the like.

Note that, as shown in FIGS. 9 to 12, depending on the constants PMax,Const and PMin,Const, part of the images of the stationary poles may be reduced. In this embodiment, by setting (PMax,Const, PMin,Const)=(0.65, 0.475) as shown in FIG. 12, it is possible to suppress the reduction of images of stationary objects. Thus, by appropriately adjusting the constants PMax,Const and PMin,Const based on the actually obtained corrected images, it is possible to suppress the influence of the position information of objects that can reduce the vehicle position estimation accuracy, while suppressing the reduction of images of stationary objects. Accordingly, it is possible to suppress a reduction in vehicle position estimation accuracy.

Further, in this embodiment, the position of the own vehicle is estimated based on the corrected image and the map image. The map image indicates the distribution of a second post-correction existence probability obtained by weighting, using a second weight corresponding to a second radar cross section acquired before the existence-probability acquisition step S21 using radar, a second existence probability that is the existence probability of objects acquired before the existence-probability acquisition step S21 using radar.

By performing vehicle position estimation using such a map image, as in the corrected image, it is possible to suppress the influence of the position information of objects that can reduce the vehicle position estimation accuracy in the map image. Accordingly, since the position information of stationary objects is prevented from being buried in the position information of vegetation and the like in the map image, it is possible to suppress a reduction in vehicle position estimation accuracy due to vegetation and the like.

### Modifications, Etc.

While the vehicle position estimation methods and the like according to one aspect of the present invention have been described based on embodiments, the present invention is not limited to the embodiments. Various modifications conceived by those skilled in the art without departing from the spirit of the present invention may also be included within the scope of the present invention.

For example, in the above embodiments, an example in which the mobile body V10 is used as an example of a mobile body has been shown, but the mobile body is not limited to the mobile body V10. It suffices that the object is capable of moving on a road and its position can be estimated by the vehicle position estimation system 100.

The principles described above for assigning weights to objects observed via radar to identify objects of interest (e.g., stationary objects in the above examples) can be applied to identified one or more other types of objects of interest. For example, the above techniques can be applied to identification of moving objects by assigning higher weights to moving objects and lower weights to stationary objects. Based on the identification of moving objects, moving object trajectories can be determined (e.g., based on velocity data from the radar and/or based on changes in position overtime). Such moving object trajectories may be used for vehicle control, such as to predict where moving objects may intersect a pathway of the vehicle and to control the vehicle accordingly so that the vehicle and moving object do not collide.

The following modes may also be included within the scope of one or more aspects of the present disclosure.
(1) Part of the components included in the vehicle position estimation system 100 described above may be a computer system consisting of a microprocessor, ROM, RAM, a hard disk unit, etc., or a server connected by a network. The RAM or hard disk unit stores a computer program. The microprocessor achieves its function by operating according to the computer program. Here, a computer program is configured by combining multiple instruction codes that indicate commands to a computer to achieve a predetermined function.
(2) Part of the components included in the vehicle position estimation system 100 described above may be configured from a single system LSI (Large Scale Integration). A system LSI is a super multifunctional LSI manufactured by integrating multiple components on a single chip and is specifically a computer system including a microprocessor, ROM, RAM, etc. The RAM stores a computer program. The microprocessor operates according to the computer program, whereby the system LSI achieves its function.
(3) Part of the components included in the vehicle position estimation system 100 described above may be configured from an IC card or a standalone module that can be attachably/detachably mounted on each device. The IC card or module is a computer system composed of a microprocessor, ROM, RAM, etc. The IC card or module may include the above-mentioned super multifunctional LSI. The IC card or module achieves its function by operating the microprocessor according to a computer program. The IC card or module may have tamper resistance.
(4) Part of the components included in the vehicle position estimation system 100 described above may be the computer program or the digital signal recorded on a computer-readable recording medium such as a flexible disk, hard disk, CD-ROM, MO, DVD, DVD-ROM, DVD-RAM, BD (Blu-ray Disc (registered trademark)), or a semiconductor memory. Alternatively, it may be the digital signal recorded on these recording media.

Part of the components included in the vehicle position estimation system 100 described above may be configured to transmit the computer program or the digital signal via an electric communication line, a wireless or wired communication line, a network such as the Internet, or data broadcasting.
(5) The present disclosure may also be the above vehicle position estimation method. It may also be a computer program for causing a computer to implement the above vehicle position estimation method, or a digital signal comprising the computer program. Furthermore, the present disclosure may be realized as a non-transitory computer-readable recording medium such as a CD-ROM on which the computer program is recorded.
(6) The present disclosure may also be a computer system that includes a microprocessor and a memory, the memory storing the above computer program, and the microprocessor operating according to the computer program.
(7) The program or the digital signal may be transferred by recording it on the recording medium and transporting it, or by transferring the program or the digital signal via the network, to be implemented by another independent computer system.

### APPENDIX

Furthermore, by the above description, the following technology is disclosed.

(Technology 1) A vehicle position estimation method for estimating the position of one's own vehicle, the vehicle position estimation method being executed by a computer, including an existence-probability acquisition step of using radar to acquire, for each position around the own vehicle, a first existence probability that is the probability of existence of an object; a radar cross-section acquisition step of using the radar to acquire a first radar cross section that is the radar cross section of the object; a corrected-image generation step of generating a corrected image indicating the distribution of a first post-correction existence probability obtained by weighting the first existence probability using a first weight that is a weight corresponding to the first radar cross section; and an estimation step of estimating the position of the own vehicle using the corrected image.

(Technology 2) The vehicle position estimation method according to Technology 1, wherein the first weight corresponding to the first radar cross section smaller than a first predetermined value is smaller than the first weight corresponding to the first radar cross section greater than the first value.

(Technology 3) The vehicle position estimation method according to Technology 1 or 2, wherein the first weight is determined based on the relationship between the value of the first radar cross section and the probability that the object is a stationary object.

(Technology 4) The vehicle position estimation method according to any one of Technologies 1 to 3, wherein the first weight for an object that is vegetation is smaller than the first weight for an object that is a stationary object.

(Technology 5) The vehicle position estimation method according to any one of Technologies 1 to 4, further comprising a map-image generation step of generating a map image including a map of a region including the position of the own vehicle, wherein, in the estimation step, the position of the own vehicle is estimated based on the corrected image and the map image.

(Technology 6) The vehicle position estimation method according to Technology 5, wherein the map image indicates the distribution of a second post-correction existence probability obtained by weighting, using a second weight corresponding to a second radar cross section acquired before the existence-probability acquisition step using radar, a second existence probability that is the existence probability of objects acquired before the existence-probability acquisition step using radar.

(Technology 7) A travel control method comprising the vehicle position estimation method according to any one of Technologies 1 to 6, and a travel control step of performing travel control of the own vehicle based on the position of the own vehicle estimated by the vehicle position estimation method.

(Technology 8) A program for causing a computer to execute the vehicle position estimation method according to any one of Technologies 1 to 6, or the travel control method of Technology 7.

(Technology 9) A vehicle position estimation device for estimating the position of one's own vehicle, the device comprising an existence-probability acquisition unit configured to use radar to acquire, for each position around the own vehicle, a first existence probability that is the probability of existence of an object; a radar cross-section acquisition unit configured to use the radar to acquire a first radar cross section that is the radar cross section of the object; a corrected-image generation unit configured to generate a corrected image indicating the distribution of a first post-correction existence probability obtained by weighting the first existence probability using a first weight that is a weight corresponding to the first radar cross section; and an estimation unit configured to estimate the position of the own vehicle using the corrected image.

(Technology 10) A mobile body comprising the vehicle position estimation device according to Technology 9, and a travel control unit configured to control travel of the own vehicle based on the position of the own vehicle estimated by the vehicle position estimation device.

1. A vehicle position estimation method for estimating the position of a vehicle, the vehicle position estimation method being executed by a computing system of the vehicle, comprising:
generating, using radar data, initial existence probabilities for objects in a region around the vehicle;
generating, using the radar data, radar cross section information for the objects in the region around the vehicle;
generating a corrected image based on the initial existence probabilities and the radar cross section information, the corrected image comprising corrected existence probabilities for the objects in the region around the vehicle obtained by weighting the initial existence probabilities using a plurality of weights corresponding to the radar cross section information; and
estimating the position of the vehicle using the corrected image.

2. The vehicle position estimation method according to claim 1, wherein weights of the plurality of weights that correspond to radar cross sections that are smaller than a first predetermined value are smaller than weights of the plurality of weights that correspond to radar cross sections greater than the first predetermined value.

3. The vehicle position estimation method according to claim 1 or 2, wherein the plurality of weights are determined based on relationships between values of the radar cross section information and the initial existence probabilities.

4. The vehicle position estimation method according to claim 1 or 2, wherein a weight of the plurality of weights for an object that is vegetation is smaller than a weight of the plurality of weights for an object that is a stationary object.

5. The vehicle position estimation method according to claim 1 or 2, wherein the position of the own vehicle is estimated based on the corrected image and a map image.

6. The vehicle position estimation method according to claim 5, wherein the map image comprises existence comprises existence probabilities of stationary objects.

7. The vehicle position estimation method according to claim 5, further comprising stitching a plurality of generated map images together into a plurality of patches, each patch corresponding to a predetermined planar area, wherein the map image used for estimating the position of the vehicle is based on the plurality of patches.

8. A travel control method comprising the vehicle position estimation method according to claim 1 or 2, and a travel control step of performing travel control of the own vehicle based on the position of the own vehicle estimated by the vehicle position estimation method.

9. A non-transitory computer-readable recording medium for use in a computer, the recording medium having a computer program recorded thereon for causing the computer to execute the vehicle position estimation method according to claim 1 or 2.

10. A vehicle position estimation system for estimating the position of one's own vehicle, comprising one or more processors and memory storing one or more programs for execution by the one or more processors, wherein the one or more programs include instructions that when executed by the one or more processors cause the system to:
generate, using radar data, initial existence probabilities for objects in a region around the vehicle;
generate, using the radar data, radar cross section information for the objects in the region around the vehicle;
generate a corrected image based on the initial existence probabilities and the radar cross section information, the corrected image comprising corrected existence probabilities for the objects in the region around the vehicle obtained by weighting the initial existence probabilities using a plurality of weights corresponding to the radar cross section information; and
estimate the position of the vehicle using the corrected image.

11. A vehicle comprising the vehicle position estimation system according to claim 10, and a travel controller configured to control travel of the vehicle based on the position of the vehicle estimated by the vehicle position estimation system.
